(19) United States
(12) Patent Application Publication
(10) Pub. No.: US 2024/0025702 A1
(43) Pub. Date: Jan. 25, 2024

(54) PANEL LIFTER FOR WORK VEHICLE

(71) Applicant: ESI ENERGY SERVICES INC., Calgary (CA)

(72) Inventors: Nate MATESICH, Phoenix, AZ (US); Jake BOYD, Phoenix, AZ (US); Rob Khaler, Phoenix, AZ (US); Travis CASPER, Phoenix, AZ (US); Dean DALY, Phoenix, AZ (US); Christopher ARGUE, Phoenix, AZ (US)

(21) Appl. No.: 18/144,379

(22) Filed: May 8, 2023

Related U.S. Application Data
(63) Continuation-in-part of application No. 17/869,944, filed on Jul. 21, 2022.

(51) Int. Cl. B66C 1/02; B66C 13/46; B66C 13/20

(52) U.S. Cl. CPC B66C 1/0243; B66C 13/46; B66C 13/20; B66C 1/0218

(57) ABSTRACT

A vacuum-assisted panel lifter includes a lifter attachment jib having a proximal end for mounting the vacuum-assisted panel lifter to an arm of a work vehicle and having a distal end that includes a rotator. The lifter includes a lifter frame rotationally mounted to the rotator and a plurality of modular vacuum-assisted lift pad assemblies. Each of the plurality of modular vacuum-assisted lift pad assemblies comprises a suction cup and a double-acting pneumatic actuator to displace the suction cup into engagement with a panel to be lifted. The double-acting pneumatic actuator furthermore creates a vacuum inside the suction cup when the suction cup engages the panel.

### CROSS-REFERENCE TO RELATED APPLICATIONS

This application is a continuation-in-part of, and claims benefit to, U.S. patent application Ser. No. 17/869,944, filed 21 Jul. 2022, entitled “Panel lifter for work vehicle.”

### TECHNICAL FIELD

The present invention relates generally to panel-lifting devices and more particularly to vacuum-assisted panel-lifting devices.

### BACKGROUND OF THE INVENTION

Various machines are known for lifting and/or manipulating panels such as, for example, photovoltaic solar panels. These machines are useful for various tasks such as loading or unloading panels or for manipulating panels for installation or removal for maintenance.

US 2008/0187428 discloses a vacuum lifter mountable on a forklift. This vacuum lifter has two rectangular channel-like beams that receive the forks of the forklift. The vacuum lifter is constrained to move in a purely vertical direction. The solar panels can thus be raised or lowered but not rotated or manipulated beyond that single degree of freedom.

US 2012/0027550 discloses a robotic manipulator for handling solar panels. The manipulator has a frame and a plurality of suction cups mounted fixedly to the frame.

Innovations are highly desirable to provide an improved panel-lifter.

### SUMMARY OF THE INVENTION

Disclosed herein is a novel vacuum-assisted panel lifter for lifting panels such as solar panels. The panel lifter employs double-acting pneumatic actuators and suction cups to engage the panel to be lifted.

An inventive aspect of the present disclosure is a vacuum-assisted panel lifter includes a lifter attachment jib having a proximal end for mounting the vacuum-assisted panel lifter to an arm of a work vehicle and having a distal end that includes a rotator. The lifter includes a lifter frame rotationally mounted to the rotator and a plurality of modular vacuum-assisted lift pad assemblies. Each of the plurality of modular vacuum-assisted lift pad assemblies comprises a suction cup and a double-acting pneumatic actuator to displace the suction cup into engagement with a panel to be lifted. The double-acting pneumatic actuator furthermore creates a vacuum inside the suction cup when the suction cup engages the panel. The panel lifter also includes a telematics module and/or a code-reading module. The telematics module provides location and time data. The code-reading module reads a code from the panel or from a pallet of panels.

The foregoing presents a simplified summary of the invention in order to provide a basic understanding of some aspects of the invention. This summary is not an exhaustive overview of the invention. It is not intended to identify essential, key or critical elements of the invention or to delineate the scope of the invention. Its sole purpose is to present some concepts in a simplified form as a prelude to the more detailed description that is discussed later. Other aspects of the invention are described below in relation to the accompanying drawings.

### BRIEF DESCRIPTION OF THE DRAWING

Further features and advantages of the present technology will become

apparent from the following detailed description, taken in combination with the appended drawings, in which:

FIG. 1 is an upper isometric view of a vacuum-assisted panel lifter having four modular vacuum-assisted lift pad assemblies in accordance with an embodiment of the present invention;

FIG. 2 is a lower isometric view of the vacuum-assisted panel lifter shown in FIG. 1;

FIG. 3 is an upper isometric view of a modular vacuum-assisted lift pad assembly for use in the vacuum-assisted panel lifter shown in FIGS. 1 and 2;

FIG. 4 is a lower isometric view of the modular vacuum-assisted lift pad assembly shown in FIG. 3;

FIG. 5 is another lower isometric view of a double-acting pneumatic actuator and valves that are integrated into the modular vacuum-assisted lift pad assembly;

FIG. 6 is an isometric view of a lifter attachment jib for connecting the vacuum-assisted panel lifter to a work vehicle such as an excavator;

FIG. 7 is an isometric view of an excavator with the vacuum-assisted panel lifter attached to the excavator, showing how the vacuum-assisted panel lifter can be used to lift a panel from a stack of panels;

FIG. 8 is an isometric view of the excavator and its attached vacuum-assisted panel lifter, shown on a flatbed trailer that is carrying stacks of panels;

FIG. 9 is an isometric view of the excavator and its attached vacuum-assisted panel lifter in which the excavator has a towing hitch to tow one or more dollies carrying stacks of panels.

It will be noted that throughout the appended drawings, like features are identified by like reference numerals.

### DETAILED DESCRIPTION

Disclosed herein is a novel panel lifter for lifting panels such as solar panels. The panel lifter is a vacuum-assisted panel lifter having suction cups that engage the panel to be lifted.

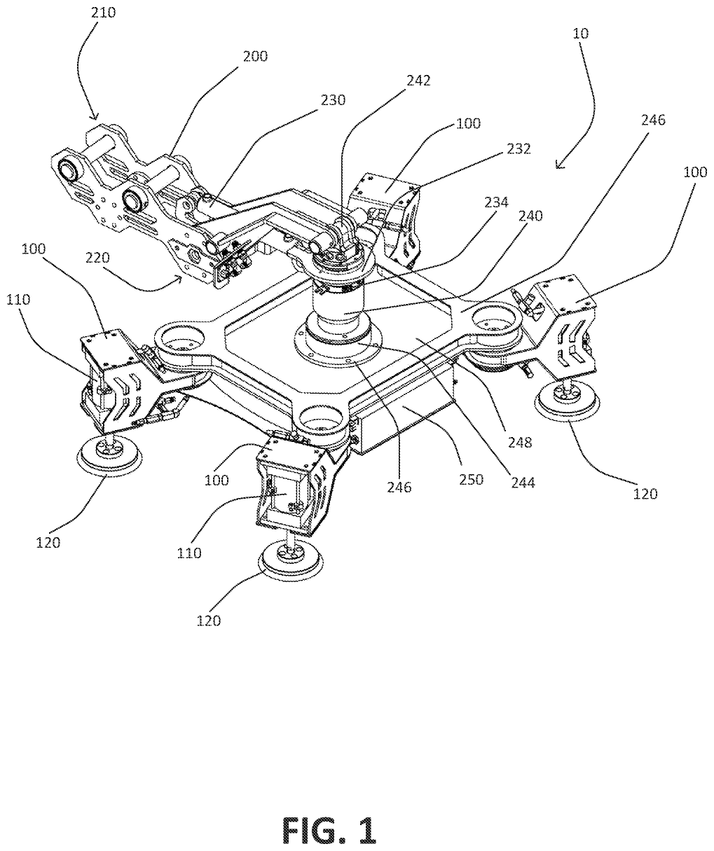

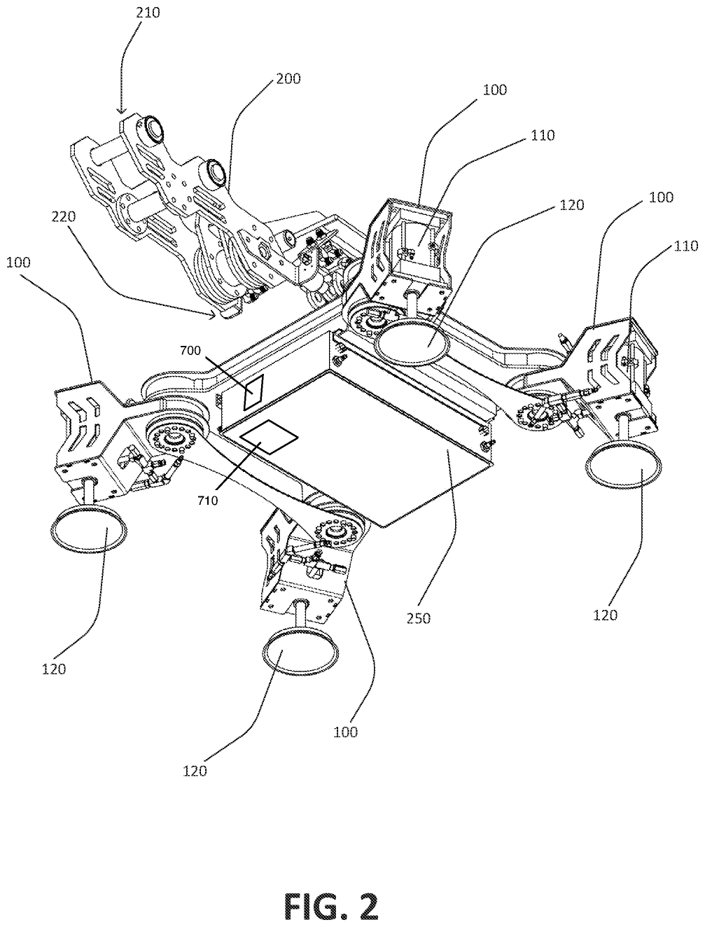

FIGS. 1 and 2 are upper and lower isometric views of a vacuum-assisted panel lifter generally designated by reference numeral 10 in accordance with an embodiment of the present invention. In the embodiment depicted in FIGS. 1 and 2, the panel lifter 10 has a plurality of modular vacuum-assisted lift pad assemblies 100. In this specific embodiment illustrated in FIGS. 1 and 2, the panel lifter 10 has four modular vacuum-assisted lift pad assemblies 100.

In the embodiment illustrated by way of example in FIGS. 1 and 2, the panel lifter 10 has a lifter attachment jib 200 having a proximal end 210 for mounting the vacuum-assisted panel lifter to an arm of a work vehicle and having a distal end 220. In this context, the proximal end is closer to an attachment point on the work vehicle whereas the distal end is father from the attachment point on the work vehicle. For example, the work vehicle may be an excavator (or mini excavator) or any other suitable vehicle having a work arm or manipulator arm to which the lifter attachment jib 200 may be mounted. Examples of a mini excavator are disclosed in EP0943739, US10315508, and US9027697, which are incorporated herein by reference. Further details and features of the lifter attachment jib 200 will be described below.

In the embodiment illustrated by way of example in FIGS. 1 and 2, the panel lifter 10 includes a rotator 240. The rotator 240 may be a hydraulic rotator. The rotator 240 may be electric or pneumatic in other variants. An upper end 242 of the rotator 240 is secured (e.g. fastened) to the distal end of the lifter attachment jib 200. A lower end 244 of the rotator 240 is mounted via an annular mounting flange 246 to a lifter frame 246. In the illustrated embodiment, the annular mounting flange 246 is fastened to an upper surface 248 of a planar structural component that is part of, or otherwise secured to, the lifter frame 246. Accordingly, in the embodiment illustrated by way of example in FIGS. 1 and 2, the lifter frame 246 is rotationally movable relative to the lifter attachment jib 200 by virtue of the rotator 240. As further illustrated in FIGS. 1 and 2, the panel lifter 10 includes an enclosure 250, i.e. a box-like housing, that is mounted to, or integrated with, the frame 246. In at least one embodiment, the enclosure 250 encloses a plurality of electric vacuum pumps and vacuum accumulators fluidly connected to the electric vacuum pumps. The vacuum accumulators are fluidly connected to the double-acting pneumatic actuators and suction cups. The enclosure 250 may also include a rechargeable battery. Optionally, the hydraulic rotator comprises a rotator bypass valve to enable the user/operator to manually rotate the lifter.

In the embodiment illustrated by way of example in FIGS. 1 and 2, the panel lifter 10 has a plurality of modular vacuum-assisted lift pad assemblies 100. In this particular embodiment, as noted above, there are four modular vacuum-assisted lift pad assemblies 100. In a variant, there may be greater than four modular vacuum-assisted lift pad assemblies or there may be fewer than four modular vacuum-assisted lift pad assemblies. In the illustrated embodiment, the modular vacuum-assisted lift pad assemblies 100 are identical components which are interchangeable. A single spare modular vacuum-assisted lift pad assembly 100 can thus be used to replace any one of the four modular vacuum-assisted lift pad assemblies if one malfunctions, requires maintenance or is damaged.

Each of the plurality of modular vacuum-assisted lift pad assemblies 100 comprises a double-acting pneumatic actuator 110 and a suction cup 120. The double-acting pneumatic actuator 110 moves the suction cup into engagement with a panel to be lifted. The double-acting pneumatic actuator 110 is furthermore able to create a vacuum inside the suction cup when the suction cup engages the panel. For the purposes of this specification, the expression “vacuum” is mean to include a partial vacuum, i.e. a pressure less than 1 atm.

In the embodiment illustrated by way of example in FIGS. 1 and 2, the lifter attachment jib 200 includes a tilt actuator 230 connected to a tilt collar 232 to tilt the rotator and the lifter frame relative to the lifter attachment jib. This tilt actuator 230 may be pneumatic, hydraulic or electric. The tilt actuator 230 may comprise a tilt actuator bypass valve which, when activated, causes the lifter frame to be oriented in a horizontal posture under a force of gravity.

In the embodiment illustrated by way of example in FIGS. 1 and 2, the panel lifter 10 comprises an electrical slip ring 234 connected to the rotator. As noted above, the lifter frame or more specifically its enclosure 250 may comprise a battery or battery pack having one or more electrochemical cells. The battery may be rechargeable such as a LiPo, NiCd, or NiMH battery. Due to the presence of the electrical slip ring 234, the battery is rechargeable by the work vehicle, i.e. by electrical connection to an alternator, generator, vehicle battery, or any other functionally equivalent electrical source disposed within the vehicle.

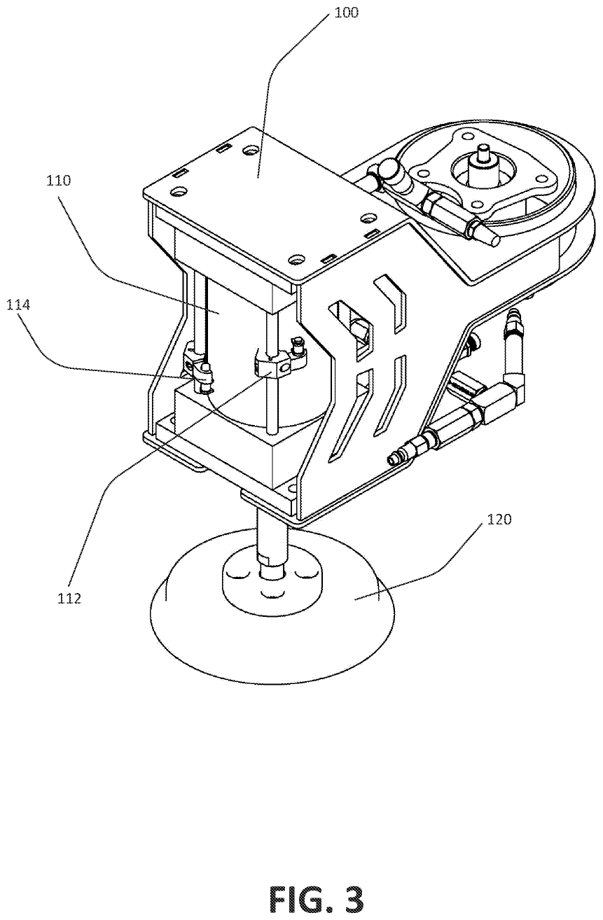

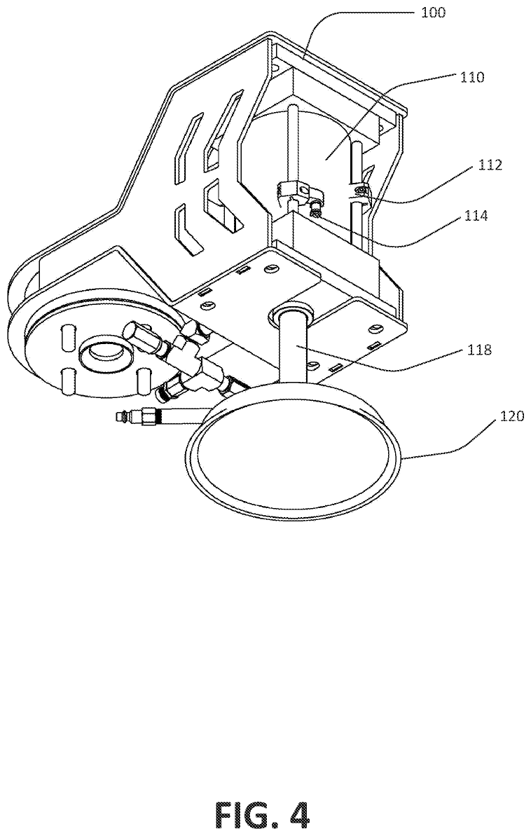

FIGS. 3 and 4 are upper and lower isometric views of a modular vacuum-assisted lift pad assembly 100 for use in the vacuum-assisted panel lifter 10 shown in FIGS. 1 and 2. The modular vacuum-assisted lift pad assembly 100 includes first and second stroke depth sensors 112, 114. The first and second stroke depth sensors 112, 114 are Hall Effect sensors in one particular variant. In other variants, these first and second stroke depth sensors are magnetic reed sensors or inductive proximity sensors. The first and second stroke depth sensors are provided to sense respectively a first stroke depth and a second stroke depth. The first stroke depth is measured when the suction cup has engaged the panel and has been stroked to generate an initial vacuum. The second stroke depth is measured when the panel has been lifted (i.e. the lifter is under load). The panel lifter may include a microcontroller programmed or configured to release the panel only when the microcontroller receives a signal from the first stroke depth sensor 112 that a stroke of the double-acting pneumatic actuator is back at the first stroke depth. In the embodiment depicted in FIGS. 3 and 4, the modular vacuum-assisted lift pad assembly 100 includes a cylinder rod 118 that is connected to a respective suction cup 120. The rod 118 may be connected to spherical joints for spherically connecting the suction cup to the double-acting pneumatic actuator.

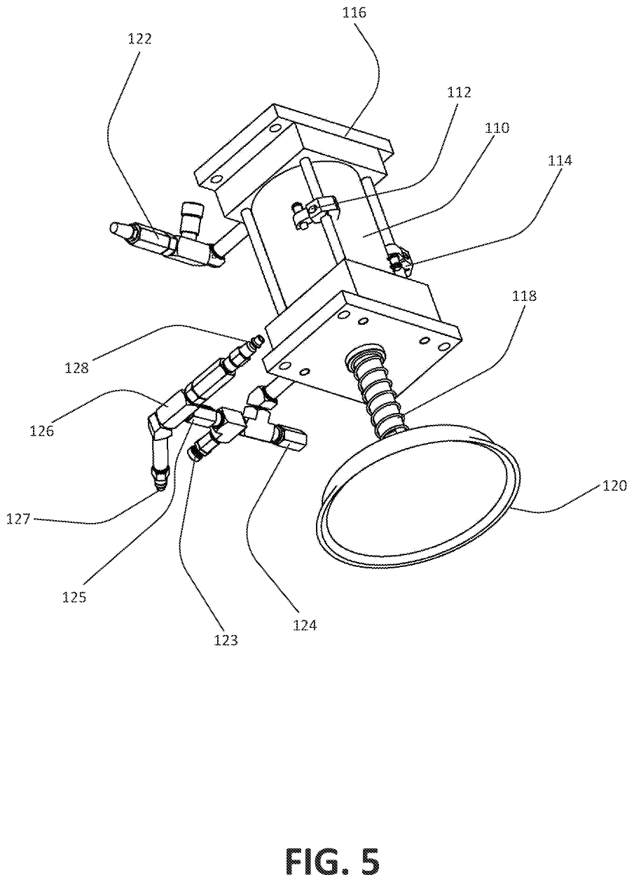

FIG. 5 is another lower isometric view of a double-acting pneumatic actuator 110 and its respective suction cup 120, also showing the valves that are integrated into the modular vacuum-assisted lift pad assembly 100. The upper end of the actuator 110 is mounted to an upper bracket 116. The lower end of the actuator includes the cylinder rod 118 that is connected to the suction cup 120 as was noted above. As further depicted in FIG. 5, the panel lifter may include a metering valve 122 to restrict a flow of air escaping from an upper chamber of the double-acting pneumatic actuator 110. The panel lifter as shown in FIG. 5 may also include an adjustable vacuum relief value 123 to set a maximum vacuum that the plunging of the piston of the double-acting pneumatic actuator produces. The panel lifter may include check valves 124, 125 to release air pressure when pistons drop during lifting. As further illustrated in FIG. 5, the check valve 125 is connected to an air conduit 126. The air conduit 126 is connected to a first fitting 127 for connecting to an air line leading to the suction cup 120. The air conduit 126 also has a second fitting 128 for connecting to an air line connected to one of the vacuum pumps. The vacuum in the suction cups can thus be generated by operating the vacuum pump(s). It is noteworthy that, in this novel panel lifter, vacuum can be generated by the vacuum pumps and/or by the stroke of the cylinder. In other words, the stroke of the cylinder and the vacuum pumps can work independently of each other or they may work conjointly. Optionally, a microcontroller is programmed or configured to control solenoids (or any other functionally equivalent devices) to regulate vacuum pumps and/or vacuum accumulators to generate a predetermined vacuum in the suction cups.

In at least one embodiment, the stroke of the cylinder can be used on its own to generate a partial vacuum (i.e. without running the vacuum pumps). This is known as initial vacuum generation. In one specific embodiment, the stroke of the cylinder generates 0.5 atm of partial vacuum or, in a variant between 0.4 and 0.6 atm, and in another variant between 0.3 and 0.7 atm, in a further variant between 0.2 and 0.8 atm and in a further variant, between 0.1 and 0.9 atm. In at least one embodiment, the weight of the panel being lifted from the stack pulls the piston downwardly to thereby create a vacuum in the upper cavity. Vacuum generation from this initial vacuum generation can be passively “checked off” (using the check valves 124, 125) to the cups and portions of the vacuum circuit to not affect vacuum when the pistons invariably drop during lifting (air volume in lower portion of the cylinder that was introduced during initial vacuum generation) is vented to atmosphere as the cylinder volume decreases.

During operation, the vehicle may include a user interface to provide a visual notification to the user of sufficient stroke of the cylinders to produce the initial vacuum. This notification may be generated based on a signal from the two Hall Effect, reed or inductive sensors indicating that the stroke length is sufficient to provide the initial vacuum. The same signal may optionally be used by the microcontroller to actuate the solenoids to control the vacuum pumps and/or accumulators to open to the suction cups without the user having to provide a further command. Once the initial of vacuum is generated for lifting the panel, the microcontroller will control the pumps to run a predetermined (programmed) vacuum level suitable for lifting the panel. The microcontroller may receive user input specifying the type, size and weight of the panel from which the appropriate vacuum is computed. Once the predetermined vacuum level is reached, the user interface of the vehicle displayed a visual indication to indicate that it is now safe to lift the panel.

Once the panel has been set down and is supporting its own weight (i.e. the panel is now resting on a solid surface), the user interface of the work vehicle will notify the user/operator. The stroke of the cylinder will then have moved to the resting (unloaded) position as indicated by the first stroke depth sensor.

To disengage a panel, the electric vacuum pumps mentioned above are connected to crossover valves to scavenge air exhaust to re-pressurize the vacuum cups (i.e. remove the lifting vacuum) in order to release the panel. Optionally, a user-operable release switch is provided in the cabin of the work vehicle to release the panel by closing off the vacuum accumulator, shuttling the crossover valves and activating the electric vacuum pumps. The switch may be a foot-operated pedal in the cabin of the work vehicle. The vehicle or lifter may include a microcontroller programmed or configured to release the panel only when both the switch is activated and the microcontroller receives a signal from the first stroke depth sensor that a stroke of the double-acting pneumatic actuator is at the first stroke depth, i.e. when both conditions are met.

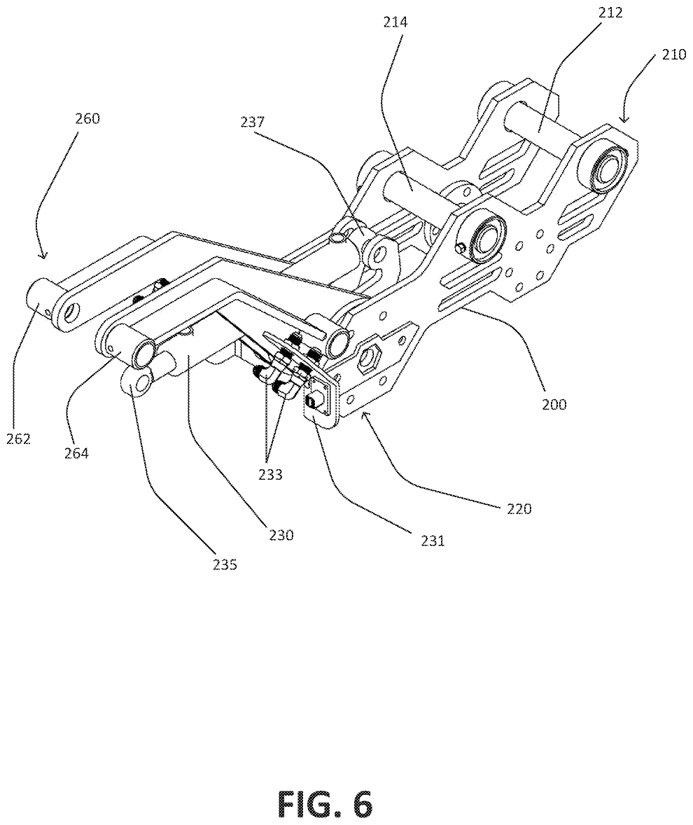

FIG. 6 is an isometric view of a lifter attachment jib 200 for connecting the vacuum-assisted panel lifter to a work vehicle such as an excavator (or more specifically a mini-excavator). At the proximal end 210 of the lifter attachment jib 200 there are attachment bolts, shafts, studs or fasteners 212, 214 to mount the lifter attachment jib to the work arm of the work vehicle. At the distal end 220, there is a bracket 231 for fluid fittings 233 for the tilt actuator 230. The distal end of the tilt actuator 230 has a distal rod end 235 whereas the proximal end of the tilt actuator 230 has a proximal rod end 237. The lifter attachment jib 200 also includes a fork 260 having a first fork member 262 and a second fork member 264 to retain the upper end 242 of the rotator as shown in FIG. 1.

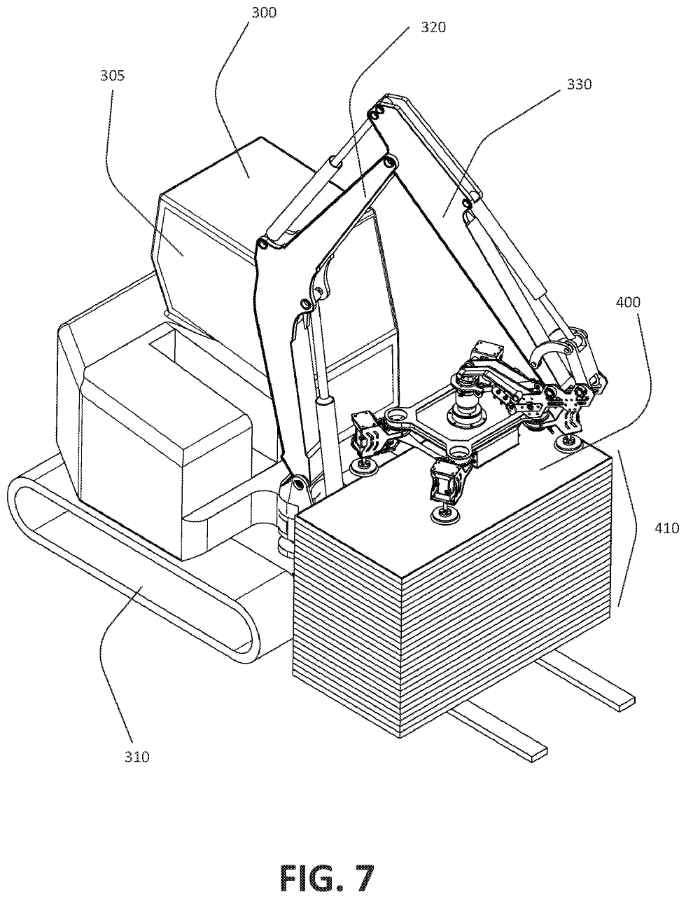

FIG. 7 is an isometric view of an excavator as an example of a work vehicle 300 with the vacuum-assisted panel lifter 10 attached to the excavator, showing how the vacuum-assisted panel lifter can be used to lift a panel 400 from a stack of panels 410. In this example, the work vehicle 300 has an operator cabin 305, tracks 310, a first arm link 320 and a second arm link 330. This work vehicle is merely one example and it will be appreciated that other types of work vehicles may be used.

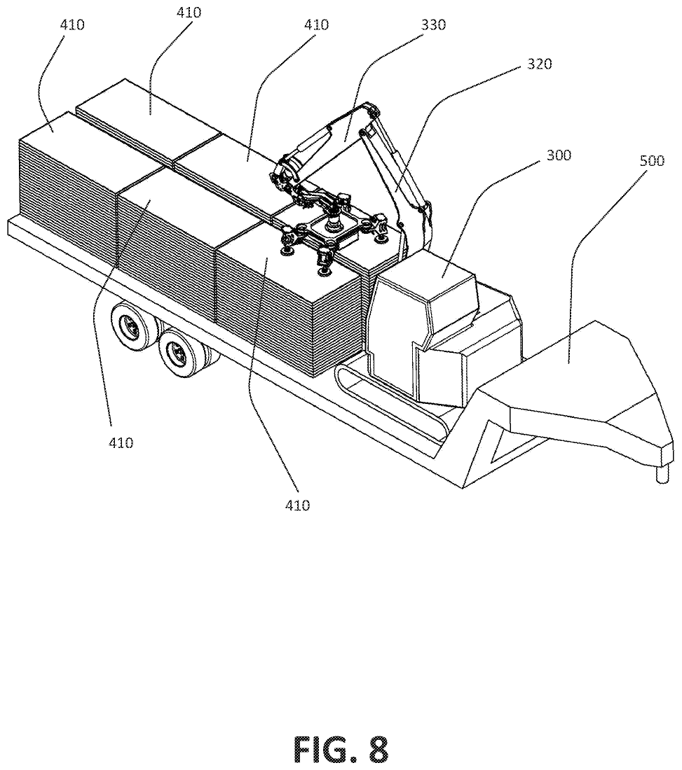

FIG. 8 is an isometric view of the excavator (work vehicle 300) and its attached vacuum-assisted panel lifter 10, shown on a flatbed trailer 500 that is carrying multiple stacks of panels 410. The flatbed trailer has a hitch to be towed by a truck. In this example, the work vehicle 300 uses the panel lifter 10 attached to its arm links 320, 330 to lift the panels from the stack of panels 410.

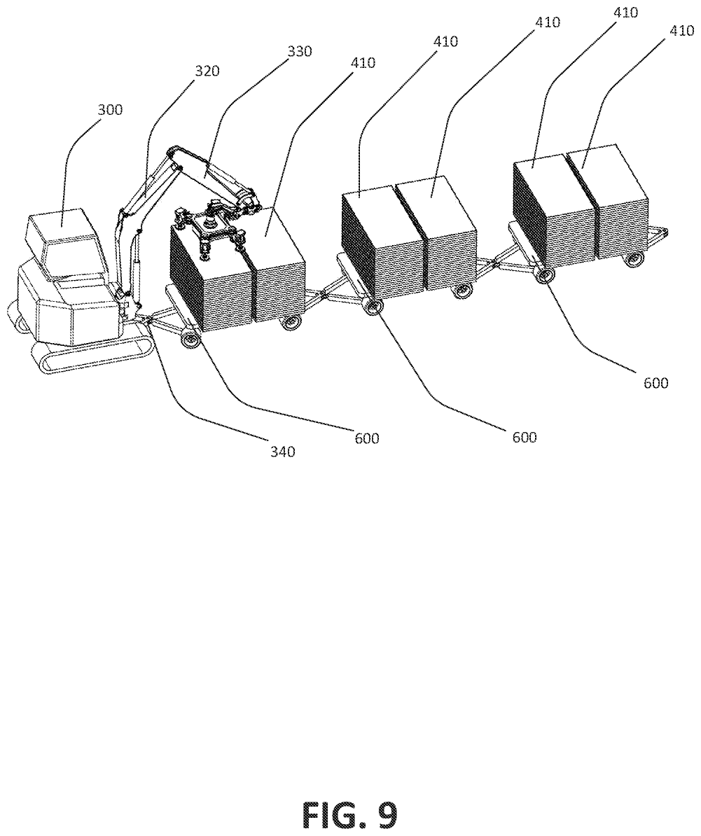

FIG. 9 is an isometric view of the excavator (work vehicle 300) and its attached vacuum-assisted panel lifter 10 mounted via first and second arm links 320, 330. The excavator has a towing hitch 310 to tow one or more dollies 600 carrying stacks of panels 410.

In one embodiment, the panel lifter includes an inertial measurement unit (IMU), a positioning device having a global navigation satellite system (GNSS) receiver, and a data communication module for transmitting data about the panel lifter to a remote monitoring device. In one specific embodiment, the panel lifter includes an inertial measurement unit (IMU), a positioning device having a global satellite navigation system (GNSS) receiver, a data logger for recording and processing acceleration data from the IMU and for determining if an acceleration exceeds a safe acceleration threshold for safe handling of the panel, and a data communication module for transmitting data about the panel lifter to a remote monitoring device either periodically or in response to the data logger determining that the acceleration has exceeded the safe acceleration threshold. For example, the GNSS receiver may be a Global Positioning System (GPS) receiver. The data communication module may include a cellular or other wireless transceiver to transmit packetized data over a cellular network or other wireless network. In addition, the panel lifter may include a data logger. Alternatively, the data logger may be on the work vehicle. The data logger may be software stored in a memory and executed by a processor coupled to the memory. The data logger receives the IMU data and then determines if there has been an event to report. An event may be a sharp acceleration or deceleration detected by the IMU that exceeds the safe acceleration threshold for safe handling of the panel. This sharp acceleration or deceleration can be correlated to a potential impact, i.e. a potentially damaging event that requires reporting back to the remote monitoring device. Alternatively, the sharp acceleration or deceleration that exceeds the safe acceleration threshold may correlate to unsafe handling maneuvers. In one implementation, an unsafe event is reported when it occurs. In another implementation, an unsafe event is stored for periodic reporting or later review by a remote supervisor using the remote monitoring device.

In one embodiment, the panel lifter comprises a telematics module denoted by reference numeral 700 in FIG. 2. The telematics modules 700 provides telematics such as time and date associated with GPS coordinates and accelerometer data from each panel picked and placed. This telematics data can be transmitted to another computer or computing device (supervisory device) for monitoring and management of operations. The telematics module 700 can be located in any other suitable location on the panel lifter or on a vehicle associated with the panel lifter.

In one embodiment, the panel lifter comprises a code-reading module denoted by reference numeral 710. The code-reading module 710 can be located in any other suitable location on the panel lifter. Multiple code-reading modules may be provided in a variant. The code-reading module 710 may include an optical reader, scanner or camera to optically read, scan or photographically extract bar codes and/or QR codes from each of the panels picked and placed and/or from the pallets holding the panels. Alternatively, the code-reading module may include an RFID reader to read an RFID tag placed on the panel and/or on the pallet. Optionally, the panel lifter includes both the telematics module and the code-reading module. The panel lifter having both the telematics module and the code-reading module is thus able to store and/or transmit panel-specific or pallet-specific time, date, location and accelerator data to a remote device or remotely located computer or server for remote supervision and management of the panel lifter. In a variant, the code-reading module 710 may have multiple readers.

For the purposes of this specification, the expression “module” is used expansively to mean any software, hardware, firmware, or combination thereof that performs a particular task, operation, function or a plurality of related tasks, operations or functions. When used in the context of software, the module may be a complete (standalone) piece of software, a software component, or a part of software having one or more routines or a subset of code that performs a discrete task, operation or function or a plurality or related tasks, operations or functions. Software modules have program code (machine-readable code) that may be stored in one or more memories on one or more discrete computing devices. The software modules may be executed by the same processor or by discrete processors of the same or different computing devices.

In one implementation, the RFID reader can be disposed on the fork attachment or any other suitable location on the panel lifter to read the RFIDs. The RFIDs can be manually attached to the pallets by the user or these RFIDs can be already pre-attached to the pallets at the panel factory. The RFID can extract data about the contents of the pallet, e.g. serial numbers, barcodes, QR codes and their packing order.

In an analogous implementation, the scanner or camera can be disposed on the panel lifter to extract information, using any suitable machine vision algorithm, from the pallet's barcode or QR code.

Optionally, the camera may be used to detect any damage or flaws (e.g. scratches or dents) in the panel prior to lifting the panel and/or after installation of the panel. The pre-existing damage or flaws may be recorded and/or transmitted to a supervisory device. Likewise, any damage incurred during handling or installation can be photographed, recorded and transmitted. For example, in one optional implementation, if the accelerometer of the panel lifter records an acceleration that is above a safe acceleration threshold, the camera can take a photograph or video to assess potential damage. Optionally, the panel lifter may use the telematics module to communicate a photo to a supervisory device to request confirmation from the supervisory device if the panel may be installed or not. The panel lifter may optionally wait to receive a confirmation message from the supervisory device before lifting and/or installing the panel. In another implementation, the panel lifter processes the image of the panel and determines if the damage is below a predetermined damage threshold. If the damage is below the predetermined damage threshold, the panel lifter proceeds to lift and install the panel. If the damage is above the predetermined damage threshold, the panel lifter lifts the damaged panel and places it elsewhere for returning to the supplier or factory. The predetermined damage threshold may be, for example, a length and/or width of a scratch or dent. Any other suitable damage characteristic may be used to assess damage. Optionally, the camera may be used to record zones of the panel requiring cleaning post installation, e.g. to remove smudges or marks, such as those left by the vacuum cups.

In another implementation, the panel lifter can form a system with one or more other machines or vehicles, e.g. tele-handlers and/or skid steers, thereby providing a system of cooperating machines in a solar field installation. In this system, the tele-handlers and/or skid steers are used to move pallets of panels around a solar field installation site. In this system, each of the tele-handlers and/or skid steers also has a telematics module and a code-reading module like the panel lifter to record GPS and accelerometer data of pallets that are moved around the site. In this system, one or more of the machines has a display that shows where the pallets are located in real-time and where the pallets should be dropped off for staging and/or installation. In an example use case, the telehandler operator can drive up to a pallet of panels, read the RFID on the pallet. The pallet location then shows on the display that is mounted in the cab of the telehandler. The display can show a map of the site that shows a graphical indicator where this particular pallet is to be taken.

For the purposes of interpreting this specification, when referring to elements of various embodiments of the present invention, the articles “a”, “an”, “the” and “said” are intended to mean that there are one or more of the elements. The terms “comprising”, “including” and “having” are intended to be inclusive and open-ended by which it is meant that there may be additional elements other than the listed elements.

This new technology has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1. A vacuum-assisted panel lifter comprising:
a lifter attachment jib having a proximal end for mounting the vacuum-assisted panel lifter to an arm of a work vehicle and having a distal end that includes a rotator;
a lifter frame rotationally mounted to the rotator;
a plurality of modular vacuum-assisted lift pad assemblies, wherein each of the plurality of modular vacuum-assisted lift pad assemblies comprises a suction cup and a double-acting pneumatic actuator to displace the suction cup into engagement with a panel to be lifted, the double-acting pneumatic actuator furthermore creating a vacuum inside the suction cup when the suction cup engages the panel; and
a telematics module for providing location and time data.

2. The panel lifter of claim 1 comprising first and second stroke depth sensors to sense respectively a first stroke depth and a second stroke depth, wherein the first stroke depth is measured when the suction cup has engaged the panel and then is stroked to generate an initial vacuum and wherein the second stroke depth is measured when the panel has been lifted.

3. The panel lifter of claim 2 comprising a microcontroller programmed or configured to release the panel only when the microcontroller receives a signal from the first stroke depth sensor that a stroke of the double-acting pneumatic actuator is at the first stroke depth.

4. The panel lifer of claim 2 wherein the first and second stroke depth sensors are Hall Effect sensors, magnetic reed sensors or inductive proximity sensors.

5. The panel lifter of claim 1, wherein the lifter attachment jib comprises a tilt actuator connected to a tilt collar to tilt the rotator and the lifter frame relative to the lifter attachment jib.

6. The panel lifter of claim 5, wherein the tilt actuator comprises a tilt actuator bypass valve which, when activated, causes the lifter frame to be oriented in a horizontal posture under a force of gravity.

7. The panel lifter of claim 1 comprising a metering valve to restrict a flow of air escaping from an upper chamber of the double-acting pneumatic actuator.

8. The panel lifter of claim 1 comprising an adjustable vacuum relief value to set a maximum vacuum that the plunging of a piston of the double-acting pneumatic actuator produces.

9. The panel lifter of claim 1 comprising check valves to release air pressure when pistons drop during lifting.

10. The panel lifter of claim 1 comprising an electrical slip ring connected to the rotator and wherein the lifter frame comprises a battery rechargeable by the work vehicle.

11. The panel lifter of claim 1 comprising a microcontroller programmed or configured to control solenoids to regulate vacuum accumulators to generate a predetermined vacuum.

12. The panel lifter of claim 1 comprising an inertial measurement unit (IMU), a positioning device having a global satellite navigation system (GNSS) receiver, a data logger for recording and processing acceleration data from the IMU and for determining if an acceleration exceeds a safe acceleration threshold for safe handling of the panel, and a data communication module for transmitting data about the panel lifter to a remote monitoring device either periodically or in response to the data logger determining that the acceleration has exceeded the safe acceleration threshold.

13. A vacuum-assisted panel lifter comprising:
a lifter attachment jib having a proximal end for mounting the vacuum-assisted panel lifter to an arm of a work vehicle and having a distal end that includes a rotator;
a lifter frame rotationally mounted to the rotator;
a plurality of modular vacuum-assisted lift pad assemblies, wherein each of the plurality of modular vacuum-assisted lift pad assemblies comprises a suction cup and a double-acting pneumatic actuator to displace the suction cup into engagement with a panel to be lifted, the double-acting pneumatic actuator furthermore creating a vacuum inside the suction cup when the suction cup engages the panel; and
a code-reading module for reading a code from the panel or from a pallet.

14. The panel lifter of claim 13, wherein the code-reading module comprises an optical reader, scanner or camera to optically read, scan or photographically extract bar codes and/or QR codes from the panel or the pallet.

15. The panel lifter of claim 13, wherein the code-reading module comprises an RFID reader to read an RFID tag on the panel or on the pallet.

16. The panel lifter of claim 14 comprising a telematics module for providing location and time data.

17. The panel lifter of claim 15 comprising a telematics module for providing location and time data.
